(19) United States
(12) Patent Application Publication
(10) Pub. No.: US 2016/0214223 A1
(43) Pub. Date: Jul. 28, 2016

(54) HOLD DOWN AND MASKING APPARATUS FOR PART PROCESSING

(71) Applicant: ENGINEERED ABRASIVES, INC., Alsip, IL (US)

(72) Inventor: Michael J. Wern, Alsip, IL (US)

(21) Appl. No.: 15/092,228

(22) Filed: Apr. 6, 2016

Related U.S. Application Data
(63) Continuation-in-part of application No. 13/798,689, filed on Mar. 13, 2013.
(60) Provisional application No. 61/658,965, filed on Jun. 13, 2012.

(51) Int. Cl. B23Q 3/06; B24C 1/10; B24C 3/20

(52) U.S. Cl. CPC B23Q 3/069; B24C 3/20; B24C 1/10

(57) ABSTRACT

The present disclosure includes a part hold-down assembly for retaining a part. The part hold-down assembly includes an upper collar, a lower collar and a resilient biasing member, in one embodiment in the form of a coil spring, retained between the upper and lower collar. The upper collar has a first end, the first end having an annular ledge. The lower collar has a second end, the second end having an annular ledge. The resilient biasing member includes a first end and a second end, the first coil end configured to engage with the annular ledge of the upper collar and the second coil end configure to engage with the second annular ledge of the lower collar. A stabilization tube may extend within a central aperture of the resilient biasing member, the stabilization tube reducing or eliminating movement of the resilient biasing member in a direction that is not parallel with the direction of the central axis of the part hold-down assembly.

### CROSS-REFERENCE TO RELATED APPLICATIONS

This application is a continuation-in-part of U.S. application Ser. No. 13/798,689, filed on Mar. 13, 2013, and entitled “Hold Down and Masking Apparatus for Part Processing,” which claims the benefit of U.S. Provisional Patent Application No. 61/658,965, filed Jun. 13, 2012 and entitled “Hold Down and Masking Apparatus for Peening Operation.” The disclosures set forth in the referenced applications are incorporated herein by reference in their entireties.

### BACKGROUND

The subject matter disclosed herein relates to a part hold-down assembly, and more particularly, a part hold-down assembly for a part processing apparatus. More particularly, the present invention includes a system, method, and apparatus for use in holding and fixturing parts in an automatic apparatus for processing parts. The hold-down device is similar to the device as shown in U.S. Pat. No. 5,272,897, which is hereby incorporated by reference.

A hold-down apparatus may be used in an automatic part processing apparatus for fully automatically processing a part or work piece by methods such as shot peening and the like. Hold-down devices as shown in U.S. Pat. No. 5,272,897 use compression or resilient biasing members secured to corresponding collars by welds to hold parts or work pieces in the apparatus. As a result of repetitive use, the resilient biasing member tends to wear on the collar and/or welds. Over time, the welds could fracture or break, resulting in potential misalignment of the resilient biasing member against the collar surface. In previous hold-down devices, the resilient biasing member attaches to a planar surface of the corresponding collar, and the end of the resilient biasing member can tend to “walk” or slip off the collar if it became dislodged or the weld breaks. This can cause misalignment or axially skewed angling of the hold-down device. The present invention is an improvement on the prior art with these potential issues.

This background information is provided to provide some information believed by the applicant to be of possible relevance to the present disclosure. No admission is intended, nor should such admission be inferred or construed, that any of the preceding information constitutes prior art against the present disclosure. Other aims, objects, advantages and features of the disclosure will become more apparent upon reading of the following non-restrictive description of specific embodiments thereof, given by way of example only with reference to the accompanying drawings.

The present disclosure provides for collars which help align and secure the resilient biasing member without attachment thereto (via welds or other methods). The collars also facilitate controlled use of the resilient biasing member relative to the apparatus. Thus, the present disclose provides for an improvement on an automatic apparatus for processing parts and a part hold-down apparatus for use with the apparatus. The hold-down apparatus includes an improved assembly, including a compressible resilient biasing member and a pair of corresponding collars positioned at opposite ends of the resilient biasing member.

According to one embodiment, a part hold-down assembly is configured to retain a part. The part hold-down assembly includes an upper collar, a lower collar and a coil resilient biasing member retained between the upper and lower collar. The upper collar has a first end, the first end having an annular ledge. The lower collar has a second end, the second end having an annular ledge. The coil resilient biasing member includes a first coil end and a second coil end, the first coil end configured to engage with the annular ledge of the upper collar and the second coil end configure to engage with the second annular ledge of the lower collar.

According to another embodiment, a part hold-down assembly further includes an optional stabilization tube that is retained within a central passage of the resilient biasing member, the stabilization tube reducing or eliminating movement of the resilient biasing member in a direction that is not parallel with the direction of the central axis of the part hold-down assembly. Accordingly, the stabilization tube reduces or prevents twisting movement of the resilient biasing member in relation to the collars, which can typically cause unintentional damage to the connection therebetween, or otherwise cause malfunctioning of the resilient biasing member. In various embodiments, the stabilization tube can include one or more contact ribs that engage with an inner surface of the resilient biasing member, and/or can permit the upper shaft to extend through a shaft-receiving aperture of the stabilization tube.

According to another embodiment, an apparatus is configured to process a part. The apparatus includes a part-hold down assembly for retaining the part in the apparatus during processing. The apparatus also includes an upper shaft configured to retain the part hold-down assembly in the apparatus and a support configured to retain the part in the apparatus. The part hold-down assembly includes an upper collar, a lower collar, and a coil resilient biasing member retained therebetween. The upper and the lower collars include an annular ledge formed in corresponding surfaces to retain a portion of a corresponding end of the coil resilient biasing member therein, the corresponding ends of the coil resilient biasing member being attached to the corresponding ends of the upper and lower collars with the ends of the coil resilient biasing member being retained in the corresponding annular ledges.

These and other advantages and features will become more apparent from the following description taken in conjunction with the drawings.

### BRIEF DESCRIPTION OF THE DRAWINGS

The present disclosure will be described hereafter with reference to the attached drawings which are given as a non-limiting example only, in which:

FIG. 1 is a perspective view of an automatic part processing apparatus for processing the part by a method such as peening, with a portion of the apparatus broken away to reveal a turntable and a set of lower spindles, and having a part hold-down assembly constructed according to the teachings of the present disclosure;

FIG. 2 is an exploded, side elevational view of the part hold-down assembly of the present invention including an assembly of collars and a resilient biasing member, show by way of illustration and not limitation, as a coil spring, disclosed herein, the collars including annular recesses for cooperative engagement with flattened ends of the spring coil body, each of the first and second collars providing an annular recess;

FIG. 3 is an exploded perspective view of the resilient biasing member and collar assembly of FIG. 2, showing in detail the annular ledge located on a collar that corresponds to one end of the spring coil body, and showing the collars are detachable from the spring coil body;

FIG. 4 is a cross-sectional view taken along the line 4-4 of FIG. 2, showing the resilient biasing member and collar assembly;

FIG. 5 is an enlarged, cross-sectional, elevational view of the resilient biasing member and collar assembly as shown in FIG. 2, showing the circumferential width of the spring coil body is slightly less than the circumferential width of the annular ledge of the collars such that the flattened ends of the spring coil body fit within the recess created by the annular ledges.

FIG. 6 is a side elevation view of an alternative embodiment of the resilient biasing member and collar assembly, showing the flattened ends of the spring coil body can be maintained within the annular ledge by means of one or more straps that extend around the entire resilient biasing member and collar assembly, or for example, otherwise hold the collar and spring coil body together;

FIG. 7 is a side elevation view of another alternative embodiment of the resilient biasing member and collar assembly, showing the flattened ends of the spring coil body can be maintained within the annular ledge by means of a sleeve surrounding the spring;

FIG. 8 is a side elevational view of an another alternative embodiment of the resilient biasing member and collar assembly including a stabilization tube extending through a coil spring;

FIGS. 9A and 9B are cross-sectional views taken along the lines 9A and 9B, respectively, in FIG. 8;

FIG. 10A is a top perspective view of a first exemplary stabilization tube;

FIG. 10B is a front perspective view of the stabilization tube of FIG. 10A;

FIG. 11A is cross-sectional view of a stabilization tube of FIG. 10A taken along the line 11A-11A in FIG. 10B; and

FIG. 11B is a cross-sectional view of the stabilization tube of FIG. 10A taken along the lines 11B-11B in FIGS. 10A and 11A.

The exemplification set out herein illustrates embodiments of the disclosure that are not to be construed as limiting the scope of the disclosure in any manner Additional features of the present disclosure will become apparent to those skilled in the art upon consideration of the following detailed description of illustrative embodiments exemplifying the best mode of carrying out the disclosure as presently perceived.

### DETAILED DESCRIPTION

While the present disclosure may be susceptible to embodiment in different forms, there is shown in the drawings, and herein will be described in detail, embodiments with the understanding that the present description is to be considered an exemplification of the principles of the disclosure. The disclosure is not limited in its application to the details of structure, function, construction, or the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of various phrases and terms is meant to encompass the items or functions identified and equivalents thereof as well as additional items or functions. Unless limited otherwise, various phrases, terms, and variations thereof herein are used broadly and encompass all variations of such phrases and terms. Furthermore, and as described in subsequent paragraphs, the specific configurations illustrated in the drawings are intended to exemplify embodiments of the disclosure. However, other alternative structures, functions, and configurations are possible which are considered to be within the teachings of the present disclosure. Furthermore, unless otherwise indicated, the term “or” is to be considered inclusive.

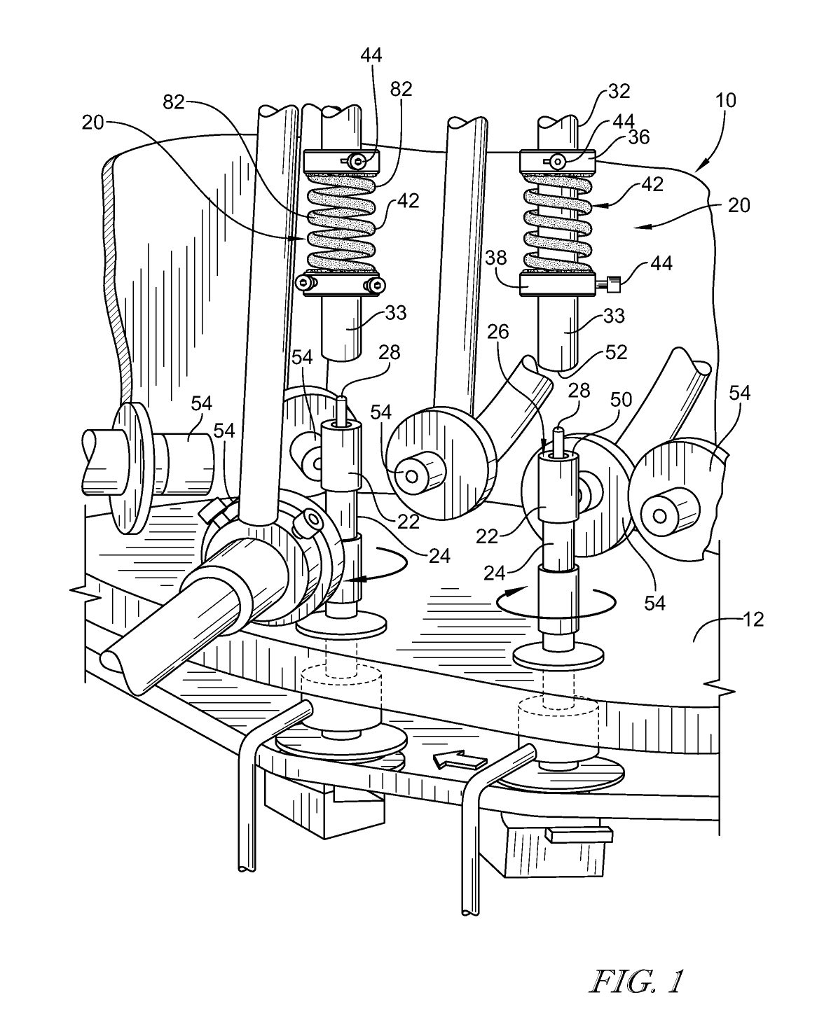

As shown in FIG. 1, a processing assembly 10 of a larger parts-processing apparatus is shown. The overall parts processing apparatus is similar to that as shown and described in U.S. Pat. No. 5,272,897. While the basic operation of this parts processing apparatus will be described hereinbelow, the primary focus of the present application will be on the structures and functions associated with a part hold-down assembly or apparatus 20. During the use of the processing apparatus, a part 22 can be fixtured on a support 24, as illustrated in FIG. 1. The part 22 may be of varying forms, but may typically be a hollow component, at least for the present configuration of the apparatus, having a generally cylindrical cavity 26 extending therethrough. An example of such a part 22 might include an automotive gear component. A shaft or pin 28 extends from the support 24 through the cavity 26 of the part 22 to help provide axial alignment of the components.

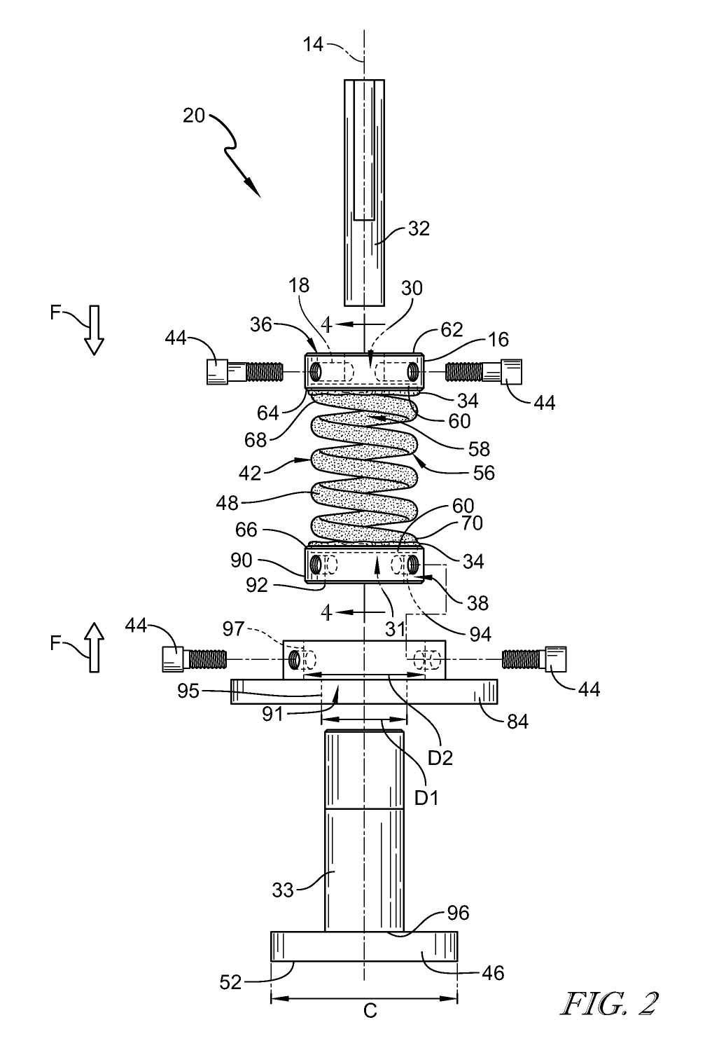

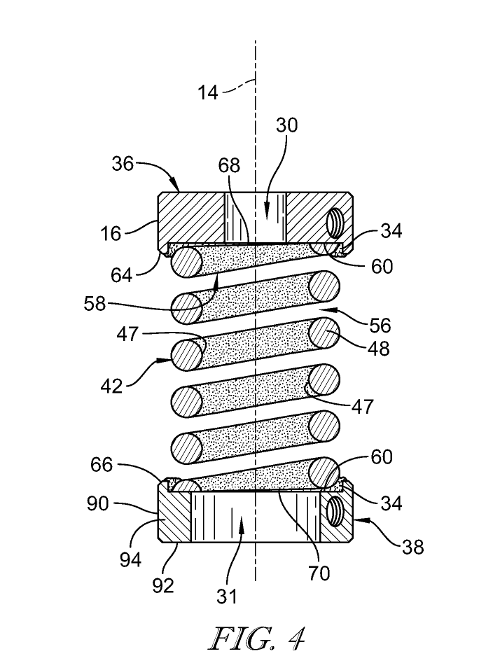

As illustrated in FIGS. 2-4, the part hold-down assembly 20 generally includes an upper collar 36, a lower collar 38, and a compression or resilient biasing member 42. The upper collar 36, lower collar 38, and resilient biasing member 42 are generally aligned to extend axially around a central axis 14 of the part hold-down assembly 20, with the part 22 being processed being retained in a position generally aligned with the central axis 14. The resilient biasing member 42 is retained between the upper and lower collars 36, 38 and configured to be moveable between a first, natural state and a second, compressed stated when a force F is applied to the upper or lower collars 36 and 38 in a direction that is generally parallel to the central axis 14. Accordingly, compression and relaxation of the resilient biasing member 42 permits varying of compression forces applied to the part 22 being processed. The upper collar 36 and the lower collar 38 may be made of any suitable material, including metals and plastics, to perform necessary function of such operation. Specific features of the upper and lower collars 36 and 38 are described in more detail later this disclosure.

The resilient biasing member 42 is shown by way of illustration and not for limitation as a coil spring 42 or other compressive structure. In various embodiments, the coil spring 42 includes a first end 68 and a second end 70, and is formed to include a central passage 58 from the first end 68 to the second end 70. The coil spring 42 is formed from one or more coils 48 wrapped in a circular manner, with each wind of the coil 48 configured to be spaced apart from an adjacent wind in its nature state so as to form one or more spaces 56 between each wind. When the coil spring 42 is compressed, the coils 48 are moved together to reduce the overall distance between the first and second ends 68 and 70 of the coil spring 42. Other forms of a resilient biasing member 42 may be used to achieve the claimed invention and every other form of such member is incorporated within the scope of this disclosure to provide the structures and functions of the invention. The resilient biasing member 42 may be made of any suitable material, include metals and plastics.

The upper collar 36 includes a circumferential side 16 that extends between a top end 62 and a coil-engaging end 64 of the upper collar 36 and a plate 18 extending radially inward from the circumferential side 16. The upper collar 36, for example the coil-engaging end 64 of the upper collar 36, is configured to engage with the resilient biasing member 42 to apply a compression force onto the resilient biasing member 42, which will thereafter transfer a compression force onto the lower collar 38. The lower collar 38 includes a circumferential side 90 that extends between a bottom end 92 and a coil-engaging end 66 of the lower collar 38 and a plate 94 extending radially inward from the circumferential side 90. The lower collar 38, for example the coil-engaging end 66 of the lower collar 38, is configured to secure the second end 70 of the coil spring 42 and to permit transfer of a compressive force from the upper collar 36 to a part 22 being processed.

The hold-down assembly 20 is carried on an upper portion of the processing assembly 10 with an upper shaft 32 providing a point of contact with the processing assembly 10. In illustrative embodiments, the upper shaft 32 is coupled to the upper collar 36. In various embodiments, the upper shaft 32 extends through a portion of an coupling aperture 30 formed in the plate 18 of the upper collar 36 in order to secure the upper shaft 32 to the upper collar 36, as illustrated in FIGS. 1 and 2. In alternative embodiments, the upper shaft 32 could extend through both the coupling aperture 30 and the central passage 58 of the coil spring 42, as also illustrated in FIGS. 1 and 2. One or more set screws 44 can be provided on the upper collar 36 for attaching the upper collar 36 to the upper shaft 32 as it extends through the coupling aperture 30, as illustrated in FIG. 2.

The hold-down assembly 20 further includes a lower shaft 33 that provides means for transferring the force applied by the hold-down assembly 20 to the part 22 being processed. In illustrative embodiments, the lower collar 38 is coupled to the lower shaft 33. In various embodiments, the lower shaft 33 extends through a portion of a coupling aperture 31 formed in the plate 94 of the lower collar 38 in order to secure the lower shaft 33 to the lower collar 38, as illustrated in FIGS. 1 and 2. In alternative embodiments, the lower shaft 33 could extend through both the coupling aperture 31 and the central passage 58 of the coil spring 42, as also illustrated in FIGS. 1 and 2. One or more set screws 44 can be provided on the lower collar 38 for attaching the lower collar 38 to the lower shaft 33 as it extends through the coupling aperture 31, as illustrated in FIG. 2.

In illustrative embodiments, the hold-down assembly 20 further includes an optional coupling shield 84, as illustrated in FIG. 2. The coupling shield 84 may extend annularly around the central axis 14 and further be positioned between the lower collar 38 and the lower shaft 33. In various embodiments, the shield 84 may block or reduce introduction of peening material that is being used to process a part below the lower shaft 33 from entering the area of the hold-down assembly 20, such as around the resilient biasing member 42. Reduction of peening material within the area of the hold-down assembly 20 may, for example, reduce the potential of the hold-down assembly 20 malfunctioning. The shield 84 may be formed to include a coupling aperture 91 through which the lower collar 38 and/or the lower shaft 33 may be at least partially retained within. The coupling aperture 91 may have a first section 95 with a first diameter D1 and a second section 97 with a second diameter D2, wherein the first diameter D1 is smaller than the second diameter D2 and thereby forms a ledge 99 within the shield 84. The ledge 99 may be configured to receive and retain the lower collar 38 within the second section 97 of the coupling aperture 91 of the shield 84, as the second diameter D2 may be configured to be the same as or larger than the diameter of the lower collar 38. Similarly, the first section 95 of the coupling aperture 91 may be configured to retain the lower shaft 33, as the first diameter D1 may be configured to be same as or larger than the diameter of the lower shaft 33. Accordingly, the shield 84 may be coupled to both the lower collar 38 and/or the lower shaft 33 via set screws 44 that extend into the coupling aperture 91, as illustrated in FIG. 2. In alternative embodiments, the shield 84 may be integrally formed with either the lower collar 38 or the lower shaft 33.

The lower shaft 33 may optionally include an end or masking portion 46 that provides a point of contact with the part being processed. The masking portion 46 includes at least a circumferential outer surface 98 and leading edge surface 52. The end or masking portion 46 can extend from a bottom end 96 of the lower shaft 33 and can be welded or otherwise fixedly attached to move with lower shaft 33. In various embodiments, the masking portion 46 may have a circumference C that is the same or greater than a circumference of the part 22 being processed. Further, the masking portion 46 may have a circumference that is the same as the circumference of the lower shaft 33. In various embodiments, the masking portion 46 is configured as part of the lower shaft 33, and the bottom end 96 of the lower shaft 33 are continuous with the leading edge surface 52.

The masking portion 46 is used to abut against a corresponding surface 50 of the part 22 in order to block or mask processing of that surface 50 of the part 22. Specifically, masking occurs by engaging the leading end surface 52 of the masking portion 46 with the corresponding surface 50 of the part 22. With the surfaces 50, 52 in face-to-face, contact the surface 50 of the part 22 is shielded or masked from the processing steps. For example, one type of process used with such processing assembly 10 may be peening. As shown in FIG. 1, a series of peening nozzles 54 may be directed in the general vicinity and direction of parts 22 carried on the processing assembly 10. Since the surface 50 of part 22 is shielded by the leading end surface 52, the peening material exiting the nozzles 54 cannot act on the surface 50 during a peening process.

With reference to FIGS. 1-5, the upper and lower collars 36, 38 and the resilient biasing member 42 are assembled together for attachment to the upper shaft 32 and the lower masking portion 46, respectively. The collars 36 and 38 permit suspension of the resilient biasing member 42 therebetween and permits application of force upon the resilient biasing member 42. The collars 36 and 38 and the resilient biasing member 42, and the interaction of these components, will now be further discussed.

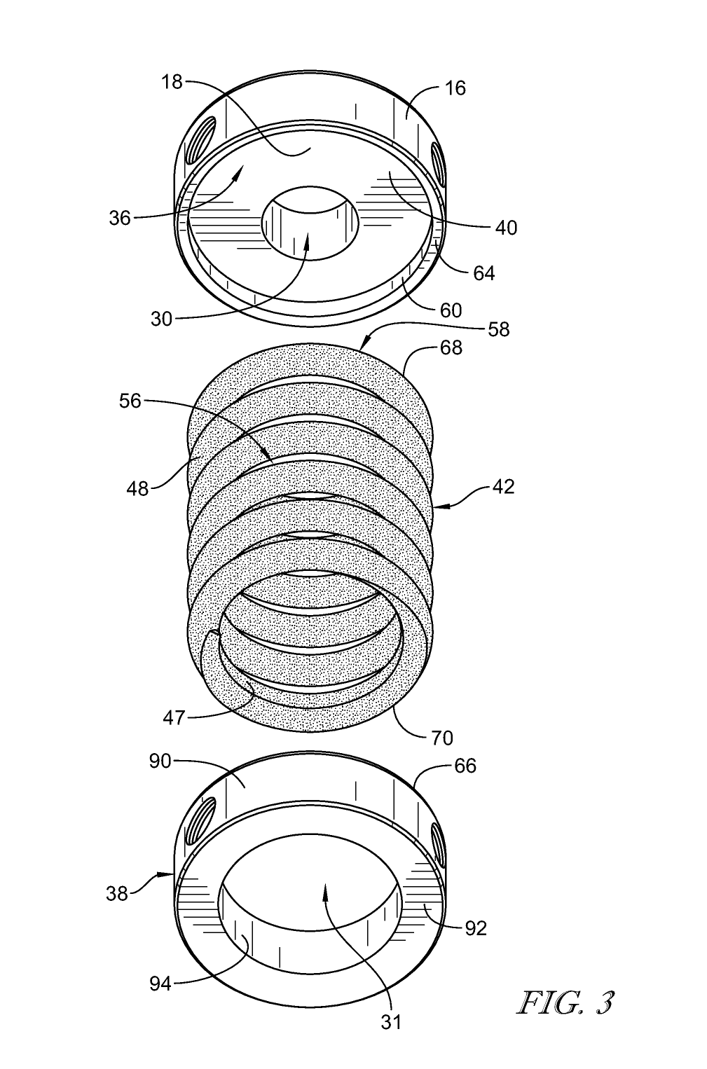

The resilient biasing member 42 of the hold-down assembly 20 may be made by various methods to achieve desired strength and resilient biasing member force within the hold-down assembly 20. The resilient biasing member 42 may, for instance, be subjected to a processing step as well, such as peening, to provide improved strength or stability characteristics. As illustrated in FIGS. 3-5, the resilient biasing member 42 includes coil ends 68, 70 that are configured to maximize engagement with contact surfaces 40 of upper and lower collars 36, 38. In illustrative embodiments, ends 68, 70 may be flattened to maximize engagement with the upper and lower collars 36, 38. The resilient biasing member 42 may be specifically sized to engage with upper and lower collars 36, 38.

While not described herein, reference is made to the incorporated patent, U.S. Pat. No. 5,272,897 with regard to the operation of the overall part processing apparatus. The processing assembly 10 receives a part 22 mounted on the support 24, which is then processed in an automated manner. The processing includes automated fixturing of the part hold-down assembly 20 against the part 22, rotation of the part 22 relative to the nozzles 54 and movement of the part 22 on a turntable 12 through a processing path. While the process itself is not the subject of the present application, the operation of the process is important because it highlights the need for the structures and functions of the part hold-down assembly 20 as disclosed herein.

As noted, the part hold-down assembly 20 includes specifically designed upper and lower collars 36, 38. Previous part processing apparatuses did not include any structure for retaining a resilient biasing member relative to a collar. As shown more explicitly in FIGS. 3-5, a corresponding annular ledge 60 is formed in corresponding coil-engaging ends 64, 66 of each collar 36, 38. The contact surfaces 40 of each collar 36, 38 are radially inward of the ledge 60. In illustrative embodiments, the ledge 60 extends from the ends 64, 66 to the contact surface 40 of each collar 36, 38. Other embodiments are also envisioned.

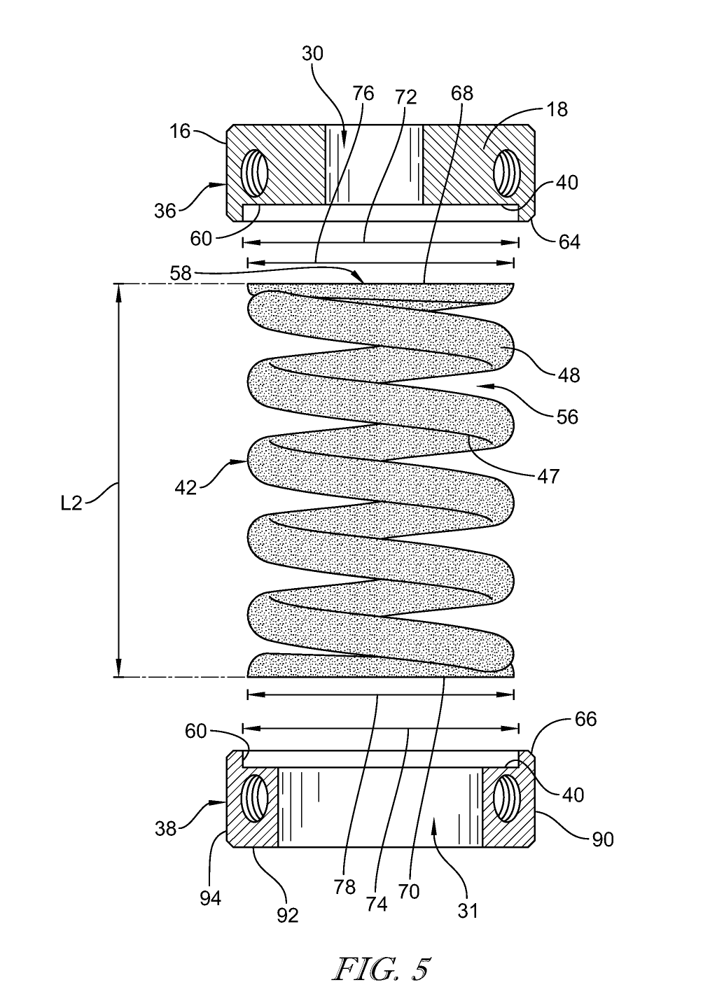

The annual ledge 60 of the collars 36, 38 helps solve an important need in the present invention and processing assembly 10. The ledge 60 allows the resilient biasing member 42 to be attached to the upper and lower collars 36, 38 in a variety of ways, all of which are structurally equivalent in the broadest sense. Additionally, the use of the annular ledge 60 and the attachment of the resilient biasing member 42 relative to the collars 36, 38 should be broadly interpreted to include all of the presently known and hereafter discovered structures to achieve this function. The annular ledge 60 is provides a fixturing and locating structure for a positive engagement between the coil ends 68, 70 of the resilient biasing member 42 and the collars 36, 38. The coil ends 68 and 70 may be flattened, for instance, by machining, as illustrated in FIG. 5. While flattened coil ends 68, 70 are shown, the coil ends 68, 70 may not be machined or formed as flattened ends, but may be formed as non-flattened ends. Either way, the coil ends 68, 70 of the resilient biasing member 42 can be retained in the annular ledge 60 the collars 36, 38.

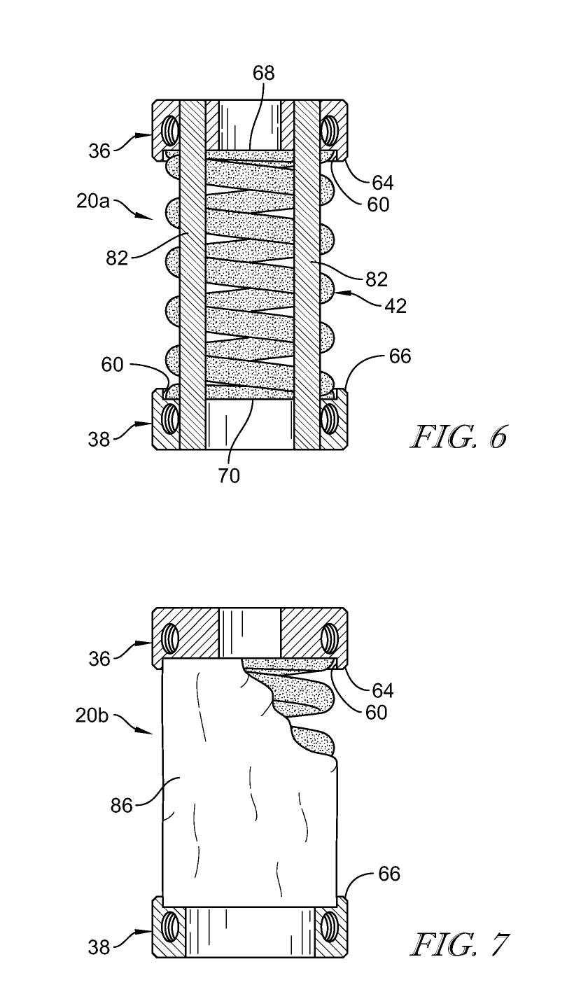

As noted above, the attachment of the resilient biasing member 42 relative to the collars 36, 38 is intended to be broadly interpreted and always possible relative to the disclosure provided herein. The coil ends 68, 70 of the resilient biasing member 42 can be welded to the contact surfaces 40 within the corresponding ledge 60 providing weld sillets 34 between the contact surface 40 and the coil ends 68, 70. Alternatively, the coil ends 68, 70 of the resilient biasing member 42 may be welded to the corresponding ends 64, 66, respectively, of the collars 36, 38. As another alternative, other means such as strapping, interference fit, or other ways of attaching the resilient biasing member 42 to the collars 36, 38 are included within the scope of the present disclosure. In an exemplary embodiment, the annular ledge 60 can be formed with an inside diameter 72, 74 which is approximately equal to and, perhaps, slightly smaller than the corresponding outside diameter 76, 78, respectively, of the coil ends 68, 70 of the resilient biasing member 42. In this regard, a tight interference fit can be formed between the ledge 60 and the coil ends 68, 70 either eliminating the need for welding, or complementing a weld 34 connection in addition to the interference fit. Additionally as described and illustrated in FIGS. 6 and 7, a strap 82, sheath 86, or other mechanical attachment can be connected between the collars 36, 38 to retain the resilient biasing member 42 therebetween in a slightly compressed manner so that the resilient biasing member 42 is retained with the collars 36, 38 as an assembly. A version of the straps 82 can be seen in FIG. 6 as an alternate embodiment 20a, and a version of the sheath 86 can be seen in FIG. 7 as another alternate embodiment 20b. Typically, an apparatus such as shown in FIG. 1 would not include a variety of means or structures for holding the parts hold-down assembly 20 together, but would incorporate one primary type of retaining the parts hold-down assembly 20.

The addition of the annular ledge 60 and the attachment of the coil ends 68, 70 of the resilient biasing member 42 in the annular ledge 60 improve the operation of the mechanism and prevent problems and damage to the mechanism as well as parts. One of the problems with the previous hold-down assemblies is that when the welds attaching the coil ends 68 70 to the collars 36, 38 broke or started to fail, the resilient biasing member 42 might shift or become misaligned relative to the overall axial alignment of the assembly. As an example, if one or multiple welds 34, but not all welds 34, in the hold-down assembly 20 failed, the hold-down assembly 20 might be misaligned relative to the part 22. This could cause jamming of the part 22 or breakage of the hold-down assembly 20. Furthermore, if the resilient biasing member 42 is not aligned with the part 22, it may not exert the right amount or direction of pressure onto the part 22, causing the part 22 to be susceptible to shiftage upon application of the peening process.

Furthermore, if the entire set of welds 34 failed so that the collars 36, 38, may no longer attach to the resilient biasing member 42. If this occurred mid-processing, the lower collar 38 and the masking portion 46 might be missing during the operation, resulting in peening of the end surface 50 of the part 22. These failures are problematic since the automated nature of the apparatus might result in detection of the failure of the welds 34 and hold-down assembly 20 only after several parts 22 have been processed. Also, failure of the system causes the apparatus to be taken down for repair incurring additional costs, process slow down, and the cost of the repair personnel, parts and other associated costs.

In contrast, even if a weld 34 breaks on the present embodiment as disclosed herein the coil ends 68, 70 of the resilient biasing member 42 will still be positively captured by the annular ledge 60 in the corresponding collars 36, 38. Additionally, if the parts 22 are manufactured with sufficiently tight tolerances to provide the interference fit, failure of the welds 34 may still not cause misalignment of disengagement of the parts 22 in the parts hold-down assembly 20. As a result, even weld 34 failures may not result in complete failure of the system.

Weld 34 failures can still be noticed as a result of periodic inspection and maintenance as carried out on previous hold-down assemblies. However, until the weld 34 failure or other component failure is detected through such inspection, the assembly can still operate and not incur down time, damage to components and other associated costs. It should be noted that the parts 22 being peened should not be damaged. As an example, failure to properly mask the end surface 50 of part 22 as a result of a failure of the hold-down assembly 20 might result in scrapping a part 22. This is important to not occur since the parts 22 are typically being prepared in a just in time process mode and there is little if any room to tolerate damage to parts. As a result, the peening process including the part hold-down assembly 20 must be constructed to prevent any damage to any part 22 during the processing steps.

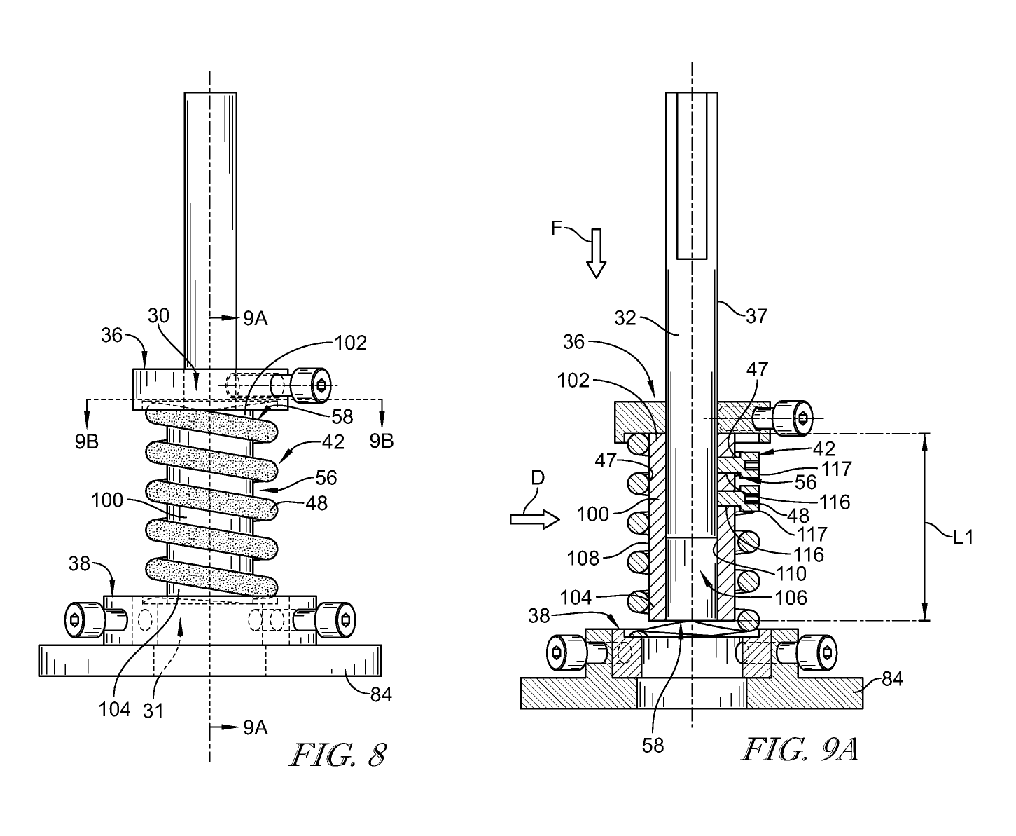

In another illustrative embodiment, the part hold-down assembly 20 may further include a stabilization tube 100, as illustrated in FIGS. 8-11B. The stabilization tube 100 may be configured to fit within the central passage 58 formed within the resilient biasing member 42 to provide a stabilization to the part hold-down assembly 20, and in particular the resilient biasing member 42, when repetitive compressive forces are applied to the part 22 being processed. For instance, the stabilization tube may provide reactive forces against the coils 48 of the resilient biasing member 42 to prevent the coils 48 from moving radially inward toward the central axis 14, and may further reduce or prevent the coils 48 from moving in a direction that is not parallel to the central axis 14. In such a manner, the stabilization tube 100 provides reduction or prevention of the coils 48 moving in a direction that causes a twisting motion at the welds 34 of the resilient biasing member 42 to the upper and lower collars 36 and 38, wherein such twisting motion may cause premature damage or malfunction of the weld 34, or the spring wire or coil 48 itself, and in turn, the part hold-down assembly 20. Instead, the coils 48 are encouraged to move primarily toward and away from each other such that the spaces 56 between the coils 48 are reduced or enlarged, accordingly, when forces are applied via the part hold-down assembly 20.

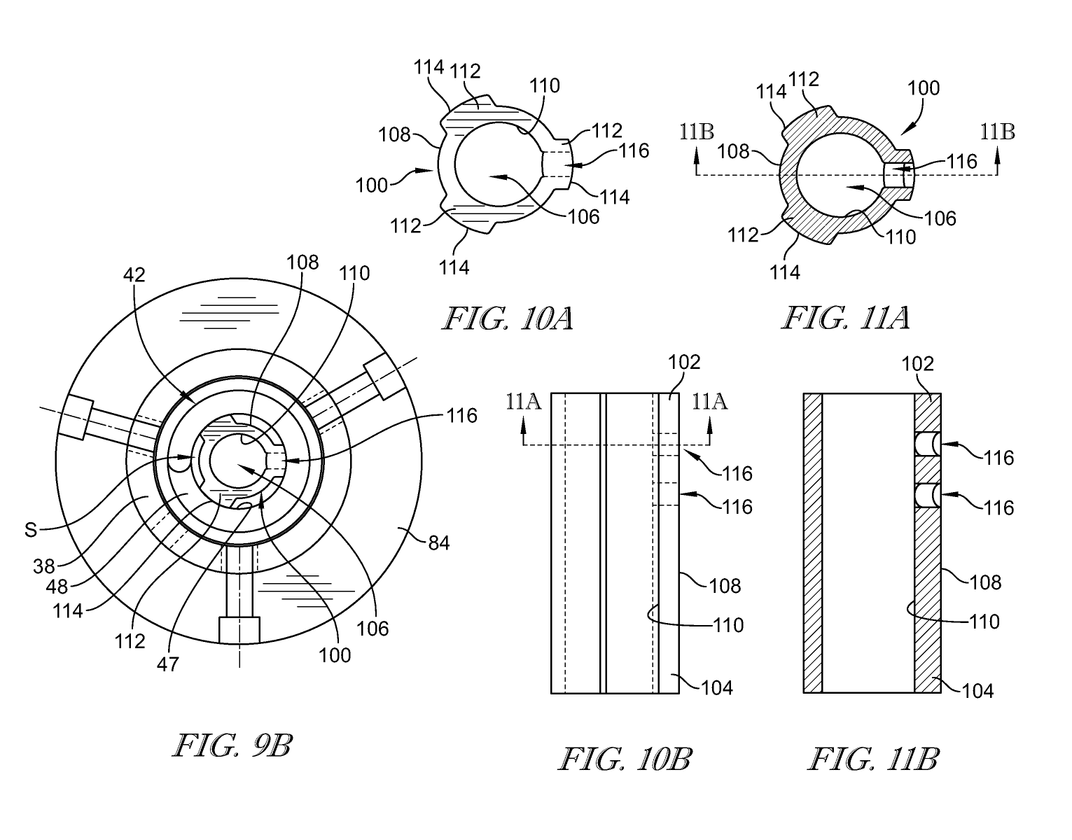

In illustrative embodiments, the stabilization tube 100 includes a first end 102 and a second end 104, and may be formed to include an optional shaft-receiving aperture 106 that extends through the stabilization tube from the first end 102 to the second end 104, as illustrated in FIG. 9A. An outer surface 108 of the stabilization tube 100 extends from the first end 102 to the second end 104 and generally defines an outer circumference of the stabilization tube 100. An inner surface 110 of the stabilization tube 100 also extends from the first end 102 to the second end 104 and generally defines the shaft-receiving aperture 106. In various embodiments, the stabilization tube 100 may have a length L1 that is equal to or less than a length L2 of the resilient biasing member 42 in an uncompressed or unbiased state (as illustrated in FIG. 5).

The stabilization tube 100 is generally configured to extend circumferentially around the central axis 14 such that the upper shaft 32 aligns with and can extend into the shaft-receiving aperture 106 of the stabilization tube 100. For instance, as noted above, the shaft 32 may be configured to extend through the coupling aperture 30 formed in the upper collar 36 and further extend through into the shaft-receiving aperture 106 of the stabilization tube 100 when the stabilization tube 100 is positioned within the central passage 58 of the resilient biasing member 42 adjacent the upper collar 36. In various embodiments, an outer surface 37 of the upper shaft 32 may abut against the inner surface 110 of the stabilization tube 100 when the shaft 32 extends within the shaft-receiving aperture 106. Alternatively, a space may exist between the outer surface 37 of the shaft 32 and the inner surface 110 of the stabilization tube 100.

In various embodiments, the stabilization tube 100 further comprises one or more contact ribs 112 that extend circumferentially away from the outer surface 108 of the stabilization tube 100 to be positioned farther away from the central axis 14 than the outer surface 108. The contact ribs 112 may each include a contact surface 114. In various embodiments, the contact ribs 112 are configured to abut against an inside surface 47 of the resilient biasing member 42, wherein the inside surface 47 of the resilient biasing member 42 generally defines the central passage 58 of the resilient biasing member 42. In exemplary embodiments, there may be three contact ribs 112 that are uniformly spaced around the outer circumference of the outer surface 108 of the stabilization tube 100, as illustrated in FIGS. 9B-11B.

The contact ribs 112 of the stabilization tube 100 are configured to provide a limited number of points of contact between the stabilization tube 100 and the resilient biasing member 42. Specifically, the contact surface 114 of a contact ribs 112 may be configured to abut against the inside surface 47 of the resilient biasing member 42. As noted above, the stabilization tube 100 is configured to provide a counteractive surface to reduce or prevent movement of the resilient biasing member 42 in a direction that is not in line with application of force F upon the resilient biasing member 42 from the part hold down assembly 20. For instance, the stabilization tube 100 can reduce or prevent movement of a coil 48 in a direction D that is orthogonal to the direction of force F being applied, wherein such movement of the coil 48 in direction D could cause the ends 68 and 70 of the resilient biasing member 42 to twist or becoming disengaged from their connection with the collars 36 and 38, thereby causing damage to or malfunction of the part hold-down assembly 20. However, the desire to prevent movement of the coils 48 in a direction that is not parallel with the direction of force F must be weighed against a concern than errant shot peening material may become lodged or stuck between the stabilization tube 100 and the resilient biasing member, which can also cause damage to the part hold-down assembly 20 with repeated, continuous use. The contact ribs 112 permit adequate stabilization of the resilient biasing member 42 to prevent undesired movement of the resilient biasing member 42, while providing a space S between the inside surface 47 of the resilient biasing member 42 and the outer surface 108 of the stabilization tube 100 that prevents or reduces the likelihood of having processing material become intentionally stuck in the part hold-down assembly 20.

In other embodiments, the contact surface 114 of the contact ribs 112 may be configured to be spaced apart from the inside surface 47 of the resilient biasing member 42 when the stabilization tube 100 is positioned within the central passage 58. In such an embodiment, the stabilization tube 100 may permit minimal movement of the resilient biasing member 42 in a direction that is not parallel with the central axis 14, such as direction D, but then block or reduce additional movement in that direction after the resilient biasing member 42 travels a predetermined or specific distance. The contact surface 114 may also be configured to be a predetermined distance away from the inside surface 47 in order to permit movement of errant processing material therebetween, thereby preventing or reducing the likelihood of such processing material being stuck, as noted above. In various embodiments, for example, the contact surface 114 may be configured to be approximately 1/16 of an inch away from the inside surface 47 of the resilient biasing member 42. Alternative dimensions of spacing are also envisioned, and may depend on the type and amount of processing material being used.

In various embodiments, a cross-sectional view of the stabilization tube 100 may be configured to have a cross-section similar to a circle with the contact ribs 112 extending outwardly therefrom, as illustrated in FIGS. 9B-11B. In other embodiments, the stabilization tube 100 may be configured to have a cross-sectional geometry similar to a triangle or a square, with contact ribs extending at the corners of such cross-sectional geometries. Other types of cross-sectional geometries are envisioned herein for the stabilization tube 100.

In various embodiments, the stabilization tube 100 may be secured to the shaft 32 extending within the shaft-receiving aperture 106 of the stabilization tube 100. In illustrative embodiments, the stabilization tube 100 may comprise one or more screw-receiving apertures 116 that are configured to receive a set screw 117. The set screw 117 is configured to extend through the outer and inner surfaces 108 and 110 of the stabilization tube 100 and abut against the shaft 32 when the shaft is adjacent the inner surface 110 of the stabilization tube 100, retaining the shaft 32 and stabilization tube 100 in position to each other.

The stabilization tube 100 may be formed of various materials. In illustrative embodiments, the stabilization tube 100 is formed of a UHMW (Ultra High Molecular Weight) polyethylene material, which may be useful in connection with, for example, glass bead or ceramic processing material. In another illustrative embodiment, the stabilization tube 100 may be formed of steel (e.g., A2 hardened steel), which may be useful in connection with, for example, steel shot and rounded cut wire processing material. Other types of materials are envisioned within the scope of this disclosure for the stabilization tube 100, and may be dependent on the type of material being used to process the part.

By way of review, a part 22 is attached or fixtured on the support 24 of the processing assembly 10, as disclosed herein and in U.S. Pat. No. 5,272,897. The part 22 is then captured between the support 24 and the lower collar 38 of the parts hold-down assembly 20, with the part 22 being optionally captured by the upper masking portion 46 attached to the lower collar 38. The part hold-down assembly 20 includes the collars 36, 38 retaining the resilient biasing member 42 therebetween. The resilient biasing member 42 provides a degree of compressive engagement to retain the part 22 on the support 24 and may be in the form of a coil spring 42. The part hold-down assembly 20 carried on the upper shaft 32 is raised and lowered during the automated processing steps making axial alignment of the part hold-down assembly 20 relative to the part 22 carried on the support 24 an important processing step. As the part hold-down assembly 20 is axially advanced downwardly toward the part 22, the corresponding surface 52 of the masking portion 46 may engage the corresponding surface 50 of the part 22 during the processing. The processing may include, but is not limited to, peening operations. For example, the part 22 can be rotated on the lower support 24 during the processing step, during which a group of peening nozzles 54 spray peening material at the part 22 to provide processing characteristics on the part 22 surface to, in part, improve wear and durability as well as other characteristics.

The part hold-down assembly 20 includes the two collars 36, 38 securing the resilient biasing member 42 therebetween. As noted above, the collars 36, 38 include the annular ledges 60 which engage the corresponding coil ends 68, 70 of the resilient biasing member 42. As noted, the coil ends 68, 70 can be welded with a weld 34 after they are engaged in the annular ledge 60. Additionally, interference fit may be achieved by the dimensional characteristics of the coil ends 68, 70 and the corresponding annual ledges 60. Alternative embodiments of attachment to retain the resilient biasing member 42 relative to the collars 36, 38 can be obtained.

In the event of a breakage of a weld 34, the part hold-down assembly 20 can still retain the collars 36, 38 relative to the resilient biasing member 42 to facilitate ongoing processing operations of the part 22 in the overall apparatus. This prevents the resilient biasing member 42 from “walking” or slipping off of the collars 36, 38.

The part hold-down assembly 20 can further include an optional stabilization tube 100 that is retained within a central passage 58 of the resilient biasing member 42, the stabilization tube 100 reducing or eliminating movement of the resilient biasing member 42 in a direction that is not parallel with the direction of the central axis 14 of the part hold-down assembly 20. Accordingly, the stabilization tube 100 can block or prevent twisting movement of the resilient biasing member in relation to the collars 36 and 38, which can cause unintentional damage to the connection therebetween or otherwise cause malfunctioning of the resilient biasing member 42. In various embodiments, the stabilization tube 100 can include one or more contact ribs that engage with an inner surface 110 of the resilient biasing member 42, and/or can permit the upper shaft 32 to extend through a shaft-receiving aperture of the stabilization tube 100.

The foregoing terms as well as other terms should be broadly interpreted throughout this application to include all known as well as all hereafter discovered versions, equivalents, variations and other forms of the abovementioned terms as well as other terms. The present disclosure is intended to be broadly interpreted and not limited.

While the present disclosure describes various exemplary embodiments, the disclosure is not so limited. To the contrary, the disclosure is intended to cover various modifications, uses, adaptations, and equivalent arrangements based on the principles disclosed. Further, this application is intended to cover such departures from the present disclosure as come within at least the known or customary practice within the art to which it pertains. It is envisioned that those skilled in the art may devise various modifications and equivalent structures and functions without departing from the spirit and scope of the disclosure as recited in the following claims. The scope of the following claims is to be accorded the broadest interpretation so as to encompass all such modifications and equivalent structures and functions.

1. A part hold-down assembly for retaining a part, comprising:
an annular upper collar having a first end, the first end having an annular ledge;
an annular lower collar having a second end, the second end having a second annular ledge;
a compression biasing member retained between the annular upper collar and the annular lower collar, wherein the compression biasing member includes a first end, a second end, and is formed to include a central passage that extends from the first end to the second end, the first end configured to engage with the annular ledge of the upper collar and the second end configure to engage with the second annular ledge of the lower collar; and
a stabilization tube received within the central passage of the resilient biasing member, the stabilization tube including an outer surface that can engage with an inner surface of the compression biasing member.

2. The part hold-down assembly of claim 1, wherein the outer surface of the stabilization tube engages with the inner surface of the compression biasing member when the compression biasing member is moved in a direction that is not parallel to a central axis of the central passage of the resilient biasing member.

3. The part hold-down assembly of claim 1, wherein the outer surface of the stabilization tube includes one or more contact ribs configured to abut against the inner surface of the compression biasing member.

4. The part hold-down assembly of claim 2, wherein the stabilization tube includes three contact ribs spaced uniformly apart around a circumference of the outer surface.

5. The part hold-down assembly of claim 1, wherein the stabilization tube comprises ultra high molecular weight polyethylene.

6. The part hold-down assembly of claim 1, wherein the stabilization tube compresses steel.

7. The part hold-down assembly of claim 1, wherein the part-hold down assembly further comprises a shaft coupled to the upper collar.

8. The part hold-down assembly of claim 7, wherein the shaft extends through a coupling aperture in the upper collar.

9. The part hold-down assembly of claim 8, wherein the shaft at least partially extends through a shaft-receiving aperture of the stabilization tube.

10. The part hold-down assembly of claim 9, wherein the shaft abuts against an inside surface of the stabilization tube, the inside surface defining the shaft-receiving aperture.

11. The part hold-down assembly of claim 9, wherein the shaft is secured to the stabilization tube via one or more set screws that extend through the stabilization tube to abut against the shaft.

12. The part hold-down assembly of claim 1, wherein the first end and second end of the compression biasing member include a flattened portion, wherein the flattened portion of the first coil end is configured to engage with a first contact surface of the upper collar, and the flattened portion of the second coil end is configured to engage with a second contact surface of the lower collar.

13. The part hold-down assembly of claim 12, wherein the first end of the compression biasing member is configured to have a diameter equal to or greater than a diameter of the annular ledge of the upper collar and the second of the compression biasing member is configured to have a diameter equal to or greater than a diameter of the annular ledge of the lower collar.

14. The part hold-down assembly of claim 1, wherein the part hold-down assembly also includes a masking portion coupled to the lower collar, the masking portion configured to engage with the part to block peening material from contacting a portion of the part.

15. The part hold-down assembly of claim 1, wherein the compression biasing member is connected to the upper collar and the lower collar by welding.

16. The part hold-down assembly of claim 1, wherein the biasing member is in the form of a coil spring.

17. An apparatus for processing parts, comprising:
an upper shaft configured to retain the part hold-down assembly in the apparatus;
a support configured to retain the part in the apparatus; and
a part-hold down assembly for retaining the part in the apparatus during processing, the part hold-down assembly including
an annular upper collar,
an annular lower collar;
a compression biasing member retained between the annular upper collar and the annular lower collar, wherein the compression biasing member includes a first end, a second end, and is formed to include a central passage that extends from the first end to the second end, the first end configured to engage with the upper collar and the second end configure to engage with the lower collar; and
a stabilization tube received within the central passage of the resilient biasing member, the stabilization tube including an outer surface that can engage with an inner surface of the compression biasing member

18. The apparatus of claim 17, wherein the upper shaft is configured to extend through a coupling aperture of the upper collar and at least partially extend into a shaft-receiving aperture of the stabilization tube.

19. The apparatus of claim 18, wherein the first end of the compression biasing member and the second end of the compression biasing member include a flattened portion retained by annular ledges of the upper and lower collars.

20. The apparatus of claim 19, wherein the first end of the compression biasing member is configured to have a diameter equal to or greater than a diameter of the annular ledge of the upper collar and the second end of the compressing biasing member is configured to have a diameter equal to or greater than a diameter of the annular ledge of the lower collar.

21. The apparatus of claim 17, wherein the first end of the compression biasing member is welded to the upper collar and the second end of the compression biasing member is welded to the lower collar.
